(19) United States
(12) Patent Application Publication
(10) Pub. No.: US 2009/0290024 A1
(43) Pub. Date: Nov. 26, 2009

(54) PROVIDING LIVE EVENT MEDIA CONTENT TO SPECTATORS

(76) Inventors: Bradley R. Larson, Meridian, ID (US); Curt N. Van Lydegraf, Eagle, ID (US); Nathan Rieth, Meridian, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/253,142

(22) Filed: Oct. 16, 2008

Related U.S. Application Data
(60) Provisional application No. 61/054,990, filed on May 21, 2008.

(51) Int. Cl. H04N 7/18; G06F 15/16

(52) U.S. Cl. 348/159; 709/217; 348/E07.085

(57) ABSTRACT

A method of providing photographic images of live events to a remote spectator includes obtaining media content from at least one media recording device at a live event; providing a version of the content to an electronic device being used by the spectator over a network; and receiving a selection of media content or a portion of the media content selected by the spectator using the electronic device.

### BACKGROUND

Often spectators of a live event feel the desire to capture a photographic or audio remembrance of the event. However, factors such as a limited number of photographic vantage points, a large number of spectators, distance from the event, distraction, bad lighting, difficulty with camera operation, and other factors may impede a spectator from capturing a satisfactory photograph or video of the event. Additionally, some spectators are not even present at the event, such as those viewing an internet broadcast from a remote location.

At large group events, the issue of obtaining photographs, video and/or audio for spectators has previously been addressed by allowing the spectators to vie for good vantage points to see and take a photo or video or capture an audio recording. Generally, this approach results in overcrowding of the good vantage points and may be a frustrating experience for those attempting to capture photos, video, or audio at those points. Furthermore, the overcrowding of the good vantage points may result in poor quality photos, video, or audio and missed opportunities to take recordings at the precise moment in which the photo, video, or audio is desired. Moreover, remote viewers of large group events have not previously had feasible options for obtaining personalized photos, video, or audio.

Another approach to providing photographic images and/or audio recordings of large group events includes hiring a professional photographer to take photos, video recordings, and/or audio recordings of the event and later offer the results for sale to the spectators. While this approach frequently provides photography and/or audio recordings of higher quality, the photography and/or audio recordings may be costly for the spectators to purchase. Also, the content of the photography and/or audio recordings taken by the photographer may not meet the specific needs of the spectators. Additionally, consumers may be forced to purchase desired photography and/or audio recordings from the photographer in expensive packages containing unwanted photography or audio recordings.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustration of an exemplary live event according to principles described herein.

FIG. 2A is an illustration of an exemplary personal electronic device according to one embodiment of principles described herein.

FIG. 2B is an illustration of a screenshot of an exemplary internet browser according to one embodiment of principles described herein.

FIG. 3 is an illustration of an exemplary system for providing ideal recorded media content of live events to spectators, according to one embodiment of principles described herein.

FIG. 4 is an illustration of an exemplary system for providing ideal recorded media content of live events to spectators, according to one embodiment of principles described herein.

FIG. 5A is an illustration of an exemplary composite image of a live event on an exemplary personal electronic device according to one embodiment of principles described herein.

FIG. 5B is an illustration of an exemplary composite image of a live event shown in an exemplary internet browser according to one embodiment of principles described herein.

FIG. 6A is an illustration of an exemplary spectator selected image on an exemplary personal electronic device according to one embodiment of principles described herein.

FIG. 6B is an illustration of an exemplary spectator selected image shown in an exemplary internet browser according to one embodiment of principles described herein.

FIG. 7A is an illustration of an exemplary prompt to a spectator on a personal electronic device according to one embodiment of principles described herein.

FIG. 7B is an illustration of an exemplary prompt to a spectator shown in an exemplary internet browser according to one embodiment of principles described herein.

FIG. 8 is an illustration of an exemplary prompt to a spectator shown in an exemplary internet browser according to one embodiment of principles described herein.

FIG. 9 is a flowchart depicting an exemplary method of providing recorded media content of a live event to spectators, according to one embodiment of principles described herein.

FIG. 10 is a flowchart depicting an exemplary method of providing recorded media content of a live event to spectators, according to one embodiment of principles described herein.

Throughout the drawings, identical reference numbers designate similar, but not necessarily identical, elements.

### DETAILED DESCRIPTION

In some cases, it may be desirable for spectators of a live event to obtain personalized photographic still images, video images, and/or audio recordings of the live event. To address the issues of improving cost, quality, and personalization of photos, video, and/or audio recordings for spectators of a live event, the present specification describes exemplary methods and systems providing spectators with images or sound of live events. The images are obtained from photographic images of the event obtained from at least one camera situated at a vantage point. The sound may be obtained from recorded audio of the event obtained from at least one microphone or other audio transducer at the event. In some embodiments, composite images of the event may be created from a plurality of cameras at one or more vantage points. Additionally, composite or custom audio recordings of the event may be created from a plurality of microphones situated at one or more vantage points, which may not necessarily be the same vantage points used by the cameras. The spectator may then receive a printed image, video recording, audio recording or digital copy of photographs, video, and/or recorded audio in exchange for payment.

As used in the present specification and in the appended claims, the term “camera” refers to a device having a lens and aperture through which an image is projected and captured either on a physical medium, such as film, or electronically. Cameras as thus defined include, but are not limited to, digital cameras, video cameras, film cameras, and combinations thereof.

As used in the present specification and in the appended claims, the term “photographic image” or “photo” refers to both still and moving images obtained by digital or film-based cameras. Examples of photographic images as thus defined include, but are not limited to, images displayed on a computer or other screen, digital representations of images, images stored on physical media, printed images, and combinations thereof. Photographic images may also include accompanying sound.

As used in the present specification and in the appended claims, the term “audio” refers to sound, both prerecorded and recorded live at an event. Examples of “audio” as thus defined include, but are not limited to, sound recorded by microphones standalone microphones, sound recorded by microphones incorporated into a camera, sound obtained by an audio transducer from an instrument or synthesizer, prerecorded sound, and sound transmitted from a remote location.

As used in the present specification and in the appended claims, the term “spectator” refers both to persons present at a live event and persons viewing a live event remotely. For example, a remote spectator may view a live streaming broadcast of the live event or an archived recording of the live event through a network.

As used in the present specification and in the appended claims, many of the functional units described in the present specification have been labeled as “modules” in order to more particularly emphasize their implementation independence. For example, modules may be implemented in software for execution by various types of processors. An identified module or module of executable code may, for instance, include one or more physical or logical blocks of computer instructions that may, for instance, be organized as an object, procedure, or function. Nevertheless, the executables of an identified module need not be physically located together, but may include disparate instructions stored in different locations which, when joined logically together, collectively form the subsystem and achieve the stated purpose for the subsystem. For example, a subsystem of executable code could be a single instruction, or many instructions, and may even be distributed over several different code segments, among different programs, and across several memory devices. In other examples, subsystems may be implemented entirely in hardware, or in a combination of hardware and software.

As used in the present specification and in the appended claims, the term “personal electronic device” refers to an electronic apparatus configured to receive images from a central processing element such as a server. Personal electronic devices thus defined may be battery-powered and may communicate with the central processing element through a wireless connection. Personal electronic devices may also be remote computing devices (e.g., laptop and desktop computers, set-top boxes, etc.) able to communicate with the central processing system through a network such as the Internet. Other personal electronic devices thus defined may receive power and/or communicate with the central processing element through a wired connection. Examples of such personal electronic devices include, but are not limited to, personal digital assistants (PDAs), portable computers, cellular phones, wired devices provided by a venue (e.g. attached to seats), and custom devices.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to exemplary methods and systems for providing photos of live events to spectators.

### Exemplary Systems

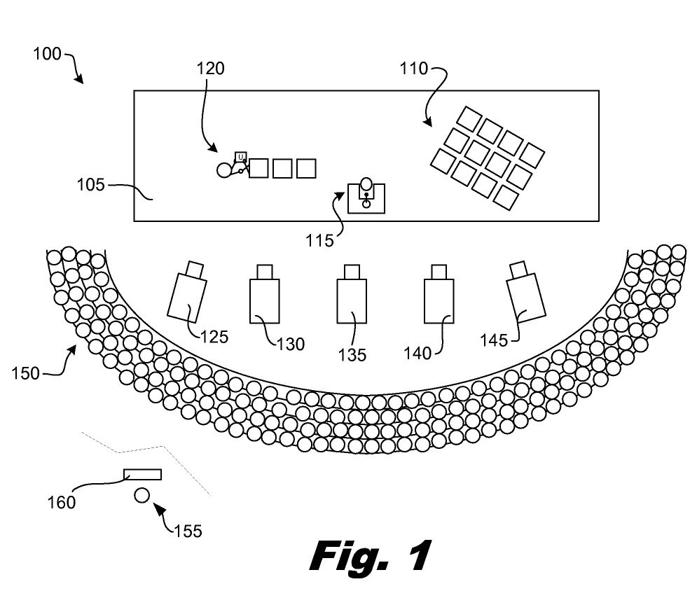

Referring now to FIG. 1, an exemplary live event (100) is shown at which personalized, high quality photographic images may be provided to a plurality of spectators (150) according to principles described herein. High quality audio of the event may also be provided to the spectators (150), with or without the photographic images. The live event (100) may include a plurality of activities occurring simultaneously in or on different portions (110, 115, 120) of a common area such as a stage (105). For example, on one portion (110) of the stage (105), a group of people may be assembled. At another portion (115) of the stage (105), a speaker may be standing at a podium. At still another portion (120) of the stage (105), a group of people may be receiving documents.

Some of the spectators (150) may take sufficient interest in the live event (100) to desire photographic memorabilia of the event (100). As widely divergent aspects of the live event (100) may appeal to different spectators (150), a demand for personalized high quality photographic images may exist among the spectators.

A plurality of cameras (125, 130, 135, 140, 145) is arranged at different vantage points of the live event (100). In some embodiments, the cameras (125, 130, 135, 140, 145) are high definition video cameras that capture continuous photographic images of the live event (100). Spectators may receive composite photographic images from the cameras (125, 130, 135, 140, 145) on personal electronic devices and select portions of the composite photographic images that they desire to keep or purchase. As used herein, the term “composite images” may refer to a feed from each of the cameras with the user being able to switch between the feeds or a tiled view simultaneously showing the feed from two or more of the cameras. The term “composite images” may also refer to an image that has been processed to include the feed from two or more of the cameras in a single, unified resulting image. This may also include composite video streams, made up of composite frames of video or image data.

At some point after the user selects an image or portions of an image for capture, the spectator-selected photographic images may then be extracted from source data of one or more of the cameras (125, 130, 135, 140, 145) and uploaded to an online service to be viewed, shared, printed or stored in physical media. Printed images and images stored in physical media may be shipped to the spectators (150) from the online service once payment is received from or arranged by the spectator (150).

In other embodiments the photographic images may be printed or put onto physical media at the venue of the live event (100) and sold to the spectators (150) at the event (100). In still other embodiments, the photographic images may be printed and made available to the spectators (150) by mail, pickup, other physical delivery, download, email, website access, or other electronic delivery.

In addition to the photographic images captured by the cameras (125, 130, 135, 140, 145), audio of the event may also be recorded by one or more microphones situated throughout the venue of the event (100). The recorded audio may be available to the spectators and included with photographic images selected by the spectators (150) or as a separate item that may be uploaded to an online service or purchased on physical media.

In some embodiments, sound may be projected through speakers or other means to the spectators (150) as part of the live event (100). In certain of these embodiments, the spectators (150) may have the option to select or purchase high-quality audio recordings of the source sound as it is output to the speakers. Recordings of the source sound may have less background noise and higher quality sound than other recordings of the event (100), thus providing a more enjoyable listening experience for some of the spectators (150).

As also shown in FIG. 1, not all the spectators may be present at the live event (100). For example, any number of remote spectators (e.g., 155) may be viewing the event from different locations. For example, the remote spectators (155) may be watching the event by television, closed circuit, cable or satellite broadcast, via the Internet or other computer network or through some other means. Furthermore, some remote spectators (155) may view or otherwise participate in the live event (100) after the event has already transpired, for example, by accessing archived recordings of the event (100) from an online service or by viewing a scheduled rebroadcast of the event (100).

Each such remote viewer (155) will have a device (160) on which to view and/or listen to the live event (100). The device (160) will include a display and associated equipment for receiving a transmission from the cameras (125-145) or other media recording devices at the live event (100). This device (160) may include, for example, a personal computer, a set-top box or similar devices.

Using the device (160), the remote spectator (155) can receive the same data as the spectators (150) at the live event receive with the personal electronic devices described above. The remote spectator (155) can then also select an image or portions of an image output by one or more of the cameras (125, 130, 135, 140, 145) and/or an audio recording and have that selection be available for purchase through an on-line service or on a physical medium as described above and as further detailed below.

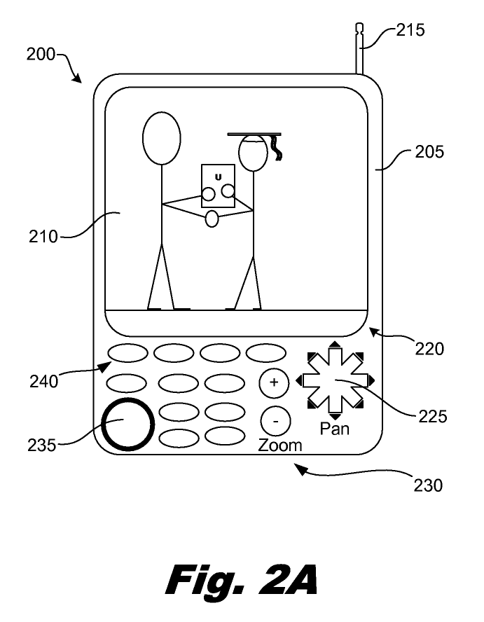

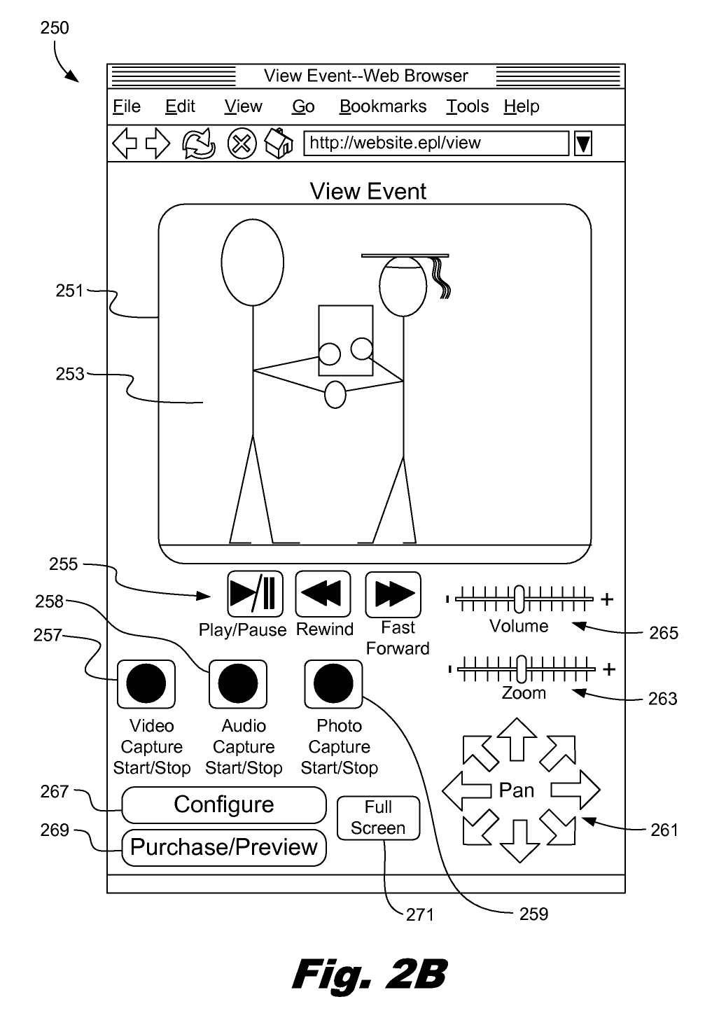

Referring now to FIGS. 2A-2B, exemplary displays (200, 250) that may be used to receive composite photographic images of a live event according to the principles described herein are shown.

As shown in FIG. 2A, an exemplary personal electronic device (200) includes a main case (205), a screen (220), and controls (225, 230, 235, 240). The exemplary personal electronic device (200) may receive a live or archived image of a live event captured by one or more of the cameras (125, 130, 135, 140, 145; FIG. 1). This image may be a composite image as defined above. The live image is transmitted wirelessly to the antenna (215) of the personal electronic device (200).

The composite photographic video image may be transmitted to the personal electronic device (200) at a much lower resolution than the resolution at which the cameras (125, 130, 135, 140, 145; FIG. 1) actually captured the constituent photographic images that make up the composite photographic image. A lower resolution may conserve bandwidth and facilitate easier reception and processing of the composite photographic image by the personal electronic device (200). Furthermore, a lower resolution composite image received on the personal electronic device (200) may discourage spectators (150, FIG. 1) from attempting to capture images by making local digital copies of the received composite photographic image on the personal electronic device (200).

The personal electronic device (200) and/or software running on the personal electronic device (200) may be designed to facilitate the selection of a portion (210) of the composite photographic image obtained by the cameras (125, 130, 135, 140, 145; FIG. 1). In some embodiments, the composite photographic image may be a panoramic video image of a live event. By adjusting centering, size, zoom, and time controls, any of an infinite number of available photographic images may be derived from the composite photographic image. As these images are available to spectators (150, FIG. 1) regardless of physical location, any of the spectators (150, FIG. 1) may capture a personalized view of any of the aspects of the live event contained in the composite photographic image.

The controls (225, 230, 235, 240) of this embodiment of the personal electronic device (200) include a pan control (225) to allow a spectator to select a certain portion of a composite photographic image received from the cameras (125, 130, 135, 140, 145; FIG. 1). Zoom controls (230) may allow the spectator to select a level of magnification according to his or her preference. Other buttons and keys (235, 240) may perform a variety of functions as indicated on the screen (220) or elsewhere such as entering text or providing answers to screen prompts. The controls of the personal electronic device (200) may also include a touch-sensitive screen (220) that can be operated with a stylus, a user's finger or the like.

The personal electronic device (200) is shown in FIG. 2A with a spectator selected photographic image (210) displayed on the screen (220). As described above, the photographic image (210) is specifically chosen by the spectator using the controls (225, 230, 235, 240)

In some embodiments, the personal electronic device (200) may be a personal digital assistant (PDA), cellular phone, or other device personally owned by a spectator. In such embodiments, the personal electronic device (200) may have special software installed permitting the spectator to access the wirelessly transmitted composite image from the cameras (125, 130, 135, 140, 145; FIG. 1) without requiring specialized hardware. For example, many personal digital assistants and cellular phones are equipped with wireless networking capabilities that could be configured to receive a wireless transmission from a server of the composite photographic image and relay position, zoom, time, and other data back to the server relating to personalized spectator-selected images. In some embodiments, the personal electronic device (200) may be specifically designed for the purpose of receiving the wireless transmission of the composite photographic image from the cameras (125, 130, 135, 140, 145; FIG. 1) at the live event (100, FIG. 1) and relaying image selection data back to the server.

The personal electronic device (200) is shown with a spectator-selected portion (210) of a composite photographic image displayed on the screen (220). This portion (210) of the composite photographic image was obtained by the spectator selecting specific location, zoom, and time coordinates of the composite photographic image received from the cameras (125, 130, 135, 140, 145; FIG. 1).

As shown in FIG. 2B, an internet browser window (250) may be used by a remote spectator (155; FIG. 1)) to receive photographic images of the live event (100, FIG. 1) over a network, such as the Internet, and display the images to the remote spectator (155; FIG. 1). The internet browser window (250) may include a display (251) in which a live or archived image of a live event captured by one or more of the cameras (125, 130, 135, 140, 145; FIG. 1) is provided to the remote spectator (155; FIG. 1). This image may be a composite image as defined above.

A remote user (155; FIG. 1) viewing the live event (100; FIG. 1) from a computer connected to the internet may desire a higher resolution in display than that used with the personal electronic device (200) of FIG. 2A. Therefore, the display (251) of the internet browser window (250) may provide the remote spectator (155; FIG. 1) with images of the live event (100; FIG. 1) from the cameras (125, 130, 135 140, 145; FIG. 1) of a sufficient resolution to provide the remote spectator (155; FIG. 1) with a satisfactory viewing experience. In some embodiments, software necessary for viewing the media content from the live event (100; FIG. 1) may be provided to a computer displaying the internet browser window (250) as part of a web application embedded in the web site.

In certain embodiments, the remote spectator (155; FIG. 1) may pay for access to the media content of the live event (100; FIG. 1). Additionally, in some embodiments, software safeguards may be used with the internet browser (250) to prevent the remote spectator (155; FIG. 1) from attempting to capture images by making unauthorized or unpurchased copies of the received composite photographic image on the computer displaying the internet browser window (250).

Like the personal electronic device (200), the exemplary internet browser window (250) may be configured to facilitate the selection of a portion (253) of the composite photographic image obtained by the cameras (125, 130, 135, 140, 145; FIG. 1). The controls (255, 257, 258, 259, 261, 263, 265) of the present embodiment of the internet browser window (250) may include playback controls (255) to navigate through media content that has already been streamed or through archived media content. Capture control buttons (257, 258, 259) may allow the remote user (155; FIG. 1) to select portions of the media content from the live event (100; FIG. 1) for uploading to an internet photo service, future retrieval, and/or purchase. A plurality of capture control buttons (257, 258, 259) may allow the user to select a type of media content to capture from the event (100; FIG. 1) (e.g. image-only video, video with audio, still images, still images with audio, and/or audio alone).

It will be understood that additional or alternative controls may be included in alternative embodiments of the principles described herein. For example, an internet browser window (250) may additionally or alternatively include controls such as, but not limited to, mouse cursor selection tools, mouse cursor drag tools, keyboard input controls, keyboard shortcut controls, voice recognition controls, and any other control in which input is received from the user to manipulate or manage the viewing, listening, capturing, storing, sharing, or purchase of media content in the internet browser window (250).

A pan control (261) may allow the spectator (155; FIG. 1) to select a certain portion of a composite photographic image received from the cameras (125, 130, 135, 140, 145; FIG. 1), while zoom controls (263) may allow the spectator (155; FIG. 1) to select a level of magnification according to his or her preference. A volume control (265) may allow the spectator (155; FIG. 1) to adjust the volume level of audio received from the live event (100; FIG. 1). A configure button (267) may provide the spectator (155; FIG. 1) with more options to manipulate the media content received, while a purchase/preview button (269) may allow the remote spectator (155; FIG. 1) to review and purchase selected media content of the live event (100; FIG. 1), as described above and in more detail below.

In some embodiments, a remote spectator (155; FIG. 1) may wish to disregard the controls (255, 257, 259, 261, 263, 265) in favor of a bigger display (251). In the present embodiment, a full screen button (271) may be provided that allows the remote spectator (155; FIG. 1) to increase the size of the display (251) in the internet browser window (250) to the full size of a screen that displays the internet browser window (250).

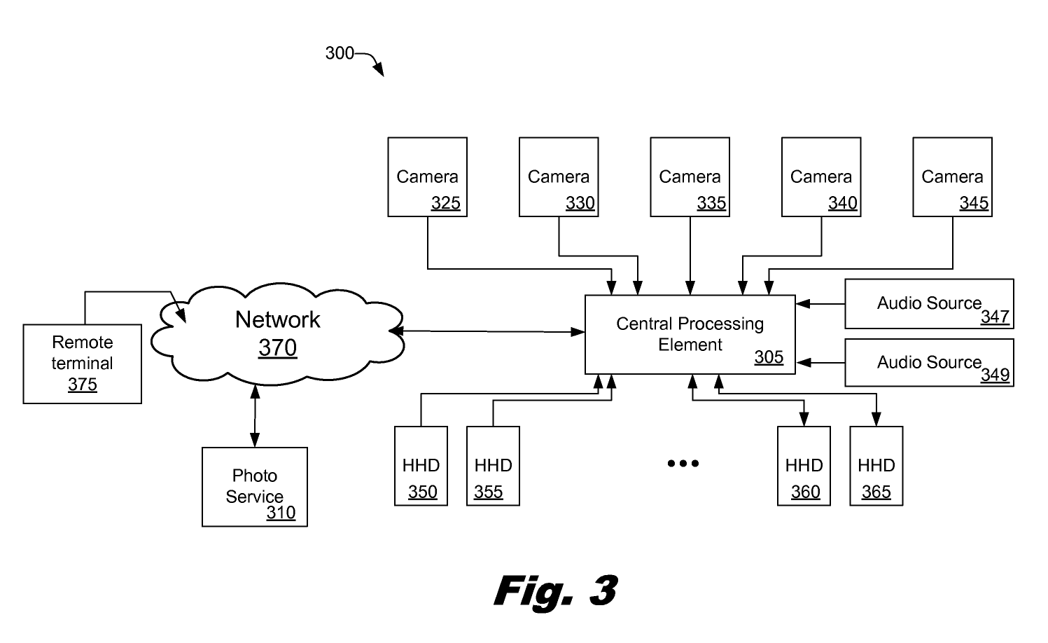

Referring now to FIG. 3, a block diagram of an exemplary system (300) for providing photographic images of live events to spectators is shown. The system (300) includes an array of cameras (325, 330, 335, 340, 345) in communication with a central processing element (305). The cameras (325, 330, 335, 340, 345) are configured to continuously stream high-definition video from different angles of a vantage point to the central processing element (305). The cameras (325, 330, 335, 340, 345) may also continuously stream high-definition video from a variety of different zoom settings or magnification settings to the central processing element (305).

The central processing element (305) may be configured to combine the high-definition video images received from the cameras (325, 330, 335, 340, 345) into a composite video image. The central processing element (305) may also be in communication with a plurality of audio sources (347, 349), such as microphones or audio lines of prerecorded audio, and configured to combine the audio received from the audio sources (347, 349) into a composite audio signal.

The central processing element (305) is also in communication with a plurality of personal electronic devices (350, 355, 360, 365) being operated by the spectators of the event. The personal electronic devices (350-365) may be spectator-owned or provided at the venue of an event. In embodiments where the personal electronic devices (350-365) are provided at the venue, the devices (350-365) may be wired devices attached to seats. In some examples, individual personal electronic devices (350-365) may be incorporated into the backs of seats.

Also, the central processing element (305) may be connected to a network (370). This network (370) may be a cable, closed circuit or computer network, including a global computer network, such as the Internet. Through this network (370), any number of remote spectators may also communicate with the central processing element (305). As shown in FIG. 3, each such remote spectator may employ a remote terminal (375), such as a computer or set-top box, to communicate via the network (370) with the central processing element (305).

The central processing element (305) is configured to continually broadcast a low-resolution version of the composite photographic image and audio to the personal electronic devices (350, 355, 360, 365) and any remote terminals (375) for remote spectators. The low-resolution version of the composite photographic image may be a video image or a periodically updated still image.

In other examples, the video and audio may be transmitted to the remote terminal (375) at a higher resolution than is transmitted to the personal electronic devices (350, 355, 360, 365), as the transmission may be the only access to the live event available to spectators who are not physically present at the live event.

Examples of central processing elements consistent with this system include, but are in no way limited to, computers, servers, application-specific integrated circuits (ASICs), other processing devices, and combinations thereof. The central processing element may, in some embodiments, be a single device. In other embodiments the central processing element (305) may include a plurality of devices in communication with each other.

A spectator may select all or a specific user-identified portion of the composite photographic image received on a personal electronic device (350, 355, 360, 365) or remote terminal (375) and elect to purchase a hard or digital copy of the selection. The selected portion may include a still image or a video. In some embodiments, sound recorded at the live event may be included with the selection or purchased separately. Coordinates relating to the center location, zoom, and time of the selected portion with respect to the composite photographic image may be relayed from the personal electronic devices (350, 355, 360, 365) or remote terminal (375) to the central processing element (305). In many embodiments, each personal electronic device (350, 355, 360, 365) or remote terminal (375) is used by a different spectator and will relay unique coordinates back to the central processing element (305).

The central processing element (305) may also be in communication with a photo service (310) through mutual connections to the network (370). However, the central processing element (305) may not necessarily be in communication with all of the cameras (325, 330, 335, 340, 345), the personal electronic devices (350, 355, 360, 365) or remote terminal (375), and the photo service (310) concurrently. The central processing element (305) may receive the center location, zoom, and time coordinates of spectator selections and creates a high-resolution version of the selection using the original images captured by the cameras (325, 330, 335, 340, 345). In many embodiments, the high-resolution version of the selection may undergo digital enhancement or processing prior to being sold to the requesting spectator. The high-resolution version is then relayed to the photo service (310) by the central processing element.

Alternatively, in some embodiments it may not be feasible or practical to directly transmit a user's selection to the photo service (310), due to the size of data files or other concerns. In such embodiments, alternative means of providing the photo service (310) access to the user selections may be used, such as remote links between the photo service (310) and the data corresponding to the user selections via an internet or other connection, or a direct connection obtained by physically moving storage media from the cameras (325, 330, 340, 345) to server accessible to the photo server (310).

Additional data identifying the specific spectator requesting the selection of the high-resolution version image may be stored and/or transmitted to the photo service (310). The requesting spectator may be identified based on the specific personal electronic device from which the image selection or request was made or by some other means.

In some embodiments, the photo service (310) may be an online photo service to which the high-resolution versions of the spectator selections may be uploaded or linked. Spectators and others may then browse their selections online and request or purchase digital copies, prints, or physical media containing the selected images and/or audio. This online photo service may be accessed via the Internet using a desktop or laptop computer or a personal electronic device. In certain embodiments, remote spectators may be able to instantaneously download or otherwise access the selected images and/or audio using the same remote terminal (375) from which the live event is being viewed and the selections are being ordered. In other embodiments, a delay for processing, physical transport of data, or other reasons may occur between when the images and/or audio are selected by the remote spectators and when the selected images and/or audio are made available to the remote spectators.

In other embodiments, the photo service (310) may include one or more photo printers located at the venue of the live event. In this way, image selections made by spectators may be purchased by the spectators during or after the live event. In still other embodiments, the spectator selections may be automatically printed or put on physical media at a photo service (310) separate from the live event and sent by mail or delivery service to the spectators after payment information has been received from the spectators or arranged.

A system (300) as described herein may be an effective way to provide royalties to copyright owners of live events. In some embodiments, spectators may be permitted to obtain photographic representations of a copyrighted live event only using a system (300) according to the principles of the present specification. In this way, the copyright owner may be justly compensated for photographic or other reproductions of the live event. Additionally, in some embodiments, a copyright owner may screen image selections of which spectators desire to obtain physical or electronic copies and deny permission to spectators to obtain copies of image selections deemed unsuitable.

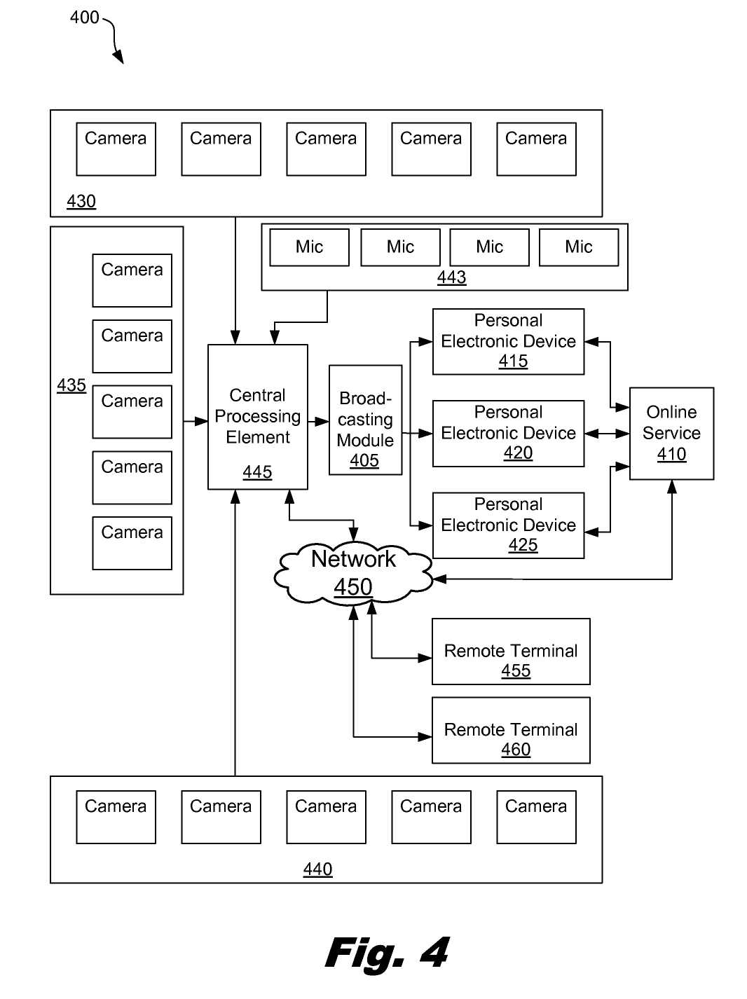

Referring now to FIG. 4, a block diagram of another exemplary system (400) for providing photographic images of live events to spectators is shown. In the exemplary system (400) of FIG. 4, a plurality of camera arrays (430, 435, 440) may be arranged at different vantage points at a live event. Each of the camera arrays (430, 435, 440) includes a plurality of high-definition cameras providing continuously updated images at different angles from its corresponding vantage point. In this particular embodiment, the three camera arrays (430, 435, 440) provide three different composite photographic images, each composite photographic image correlating to one of the vantage points at which a camera array (430, 435, 440) has been placed.

The system (400) may also include at least one audio source array (443) having a plurality of microphones arranged at different audio vantage points at the live event. The audio tracks from each of the microphones may be combined into a composite audio signal from the live event. In other embodiments, the audio tracks may be selectively used as focus shifts throughout the live event among the audio vantage points.

The camera arrays (430, 435, 440) and audio array source array (443) may be in communication with a central processing element (445), which is in turn in communication with a broadcasting module (405) configured to broadcast a low-resolution version of the composite images and audio to a plurality of personal electronic devices (415, 420, 425). The broadcasting module (405) may not necessarily establish an individual connection with each of the personal electronic devices (415, 420, 425). Rather, the personal electronic devices (415, 420, 425) may be configured to receive a universal broadcast of the low-resolution composite photographic images, thereby eliminating limitations on the number of supported devices that may be imposed using a traditional network model.

The broadcasting module (405) may broadcast over different frequencies the composite photographic images taken from the different camera arrays (430, 435, 440) at the different vantage points in addition to one or more tracks of the audio. In this manner, spectators may toggle between composite views and audio sources from the different vantage points by allowing their personal electronic devices (415, 420, 425) to change the frequencies at which they receive the data.

The broadcasting module (405) may broadcast the composite images and audio implementing any of many available standard protocols, such as IEEE 802.11, IEEE 802.16, ATSC Digital TV, Qualcomm MediFLO UHF, or future standards that may be developed. In other embodiments, a custom protocol may be used by the broadcasting module (405) and personal electronic devices (415, 420, 425). Additionally, data encryption may be used in communications between elements of the exemplary system (400).

The central processing element (445) may also be in communication with a network (450), such as the internet, through which the composite photographic images and audio may be transmitted to remote terminals (455, 460). The remote terminals (455, 460) may be configured to stream the composite photographic images and audio of the event. A user interface in the remote terminals (455, 460), such as a customized internet web page, may allow remote spectators to toggle between composite views and audio sources from the different vantage points by requesting different data feeds from the central processing element (445) through the network (450).

Each of the personal electronic devices (415, 420, 425) and the remote terminals (455, 460) of the exemplary system (400) may also be in communication with an online service (410). The personal electronic devices (415, 420, 425) may be connected to the online service (410) through a wireless or direct wired connection, while the remote terminals (455, 460) may be in communication with the online service (410) through mutual connections to the network (450).

The online service (410) may receive information about portions of the composite images and/or audio selected by spectators from the personal electronic devices (415, 420, 425) and make high-resolution versions of the spectator selections available to the spectators, typically after payments or commitments to pay have been received from the spectators. In some embodiments, the online service (410) may be implemented in the central processing element (445). In other embodiments, the online service (410) may be a separate device or program with which the personal electronic devices (415, 420, 425) communicate during or after the event.

As previously described in relation to the previous exemplary system (300, FIG. 3), in some embodiments the online service (410) may be an online photo service to which the high-resolution versions of the spectator selections are uploaded. Spectators and others may then browse their selections online and request or purchase digital copies, prints, or physical media containing the selected images or audio.

The online service (410) may allow the spectators to combine or otherwise manipulate different elements of the selections to further customize the product. For example, a spectator may add recorded audio from the audio array (443) to selected still photographic shots from the camera arrays (430, 435, 440) to create a video image which may be downloaded or recorded onto physical media.

In certain embodiments, the online service (410) may host user generated content and make the content available to other users to review, alter, and/or purchase. Additionally or alternatively, the online service (410) and/or third party vendors may manipulate or edit the media content and provide it to other users of the online service (410) to review, alter, and/or purchase.

In examples where multiple audio tracks from the audio array (443) are made available to the spectators, a spectator may be able to create a custom audio mix of selected tracks by adjusting volume levels and/or equalizer settings for each of the tracks in the mix.

In other embodiments, the photo service (410) may include one or more photo printers located at the venue of the live event. In this way, image selections made by spectators may be purchased by the spectators during or after the live event. In still other embodiments, the spectator selections may be automatically printed or put on physical media at a photo service (410) separate from the live event and sent by mail or other delivery service to the spectators after payment information has been received from the spectators.

In some embodiments, the broadcasting module (405) and the online service (410) are implemented in physically separate devices. In other embodiments, the broadcasting module (405) and the online service (410) are governed by one central processing element, such as a server or other computer.

### Exemplary Spectator Interfaces

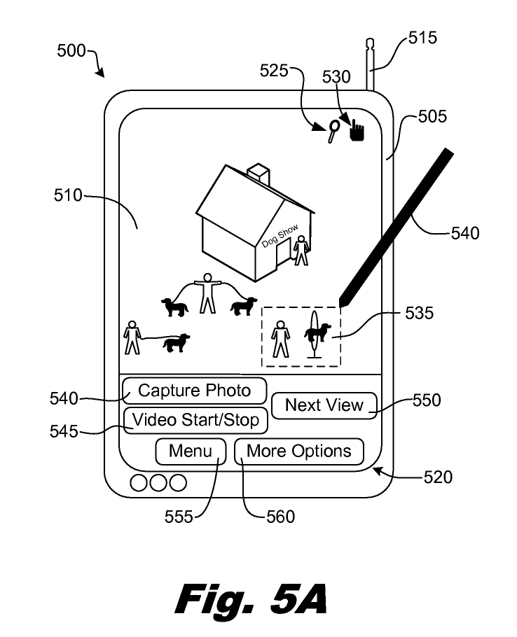

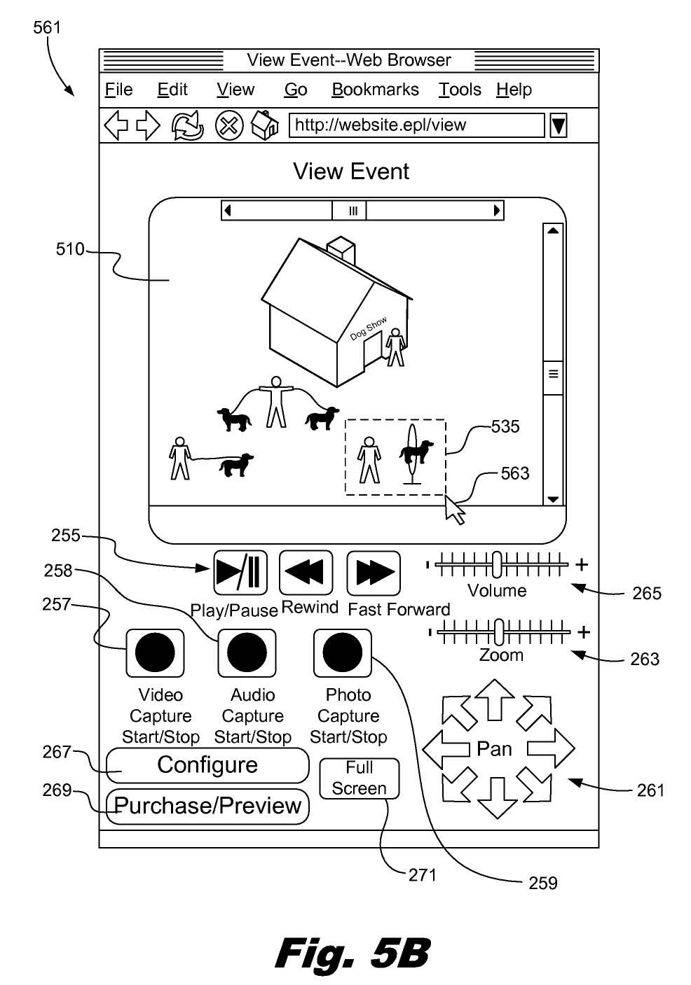

Referring now to FIG. 5A, another exemplary personal electronic device (500) is shown. The personal electronic device (500) includes a main case (505), a screen (520) and an antenna (515). The screen of this embodiment may be a touch-sensitive screen that is designed to both display information and images and receive user input from a stylus (540) or a user's finger or the like. The personal electronic device (500) may be a PDA or cellular phone owned by the spectator running special software provided to the spectator. In other embodiments, the personal electronic device (500) may be a device specifically designed for use with the systems of the present specification that is rented or purchased by the spectator. In yet other embodiments, personal electronic devices (500) may be remote spectator-owned computing devices (e.g., laptop and desktop computers, set-top boxes, etc.) able to communicate with the central processing system through a network such as the Internet. It is conceivable that in some embodiments, a mixture of both spectator-owned PDAs or cellular phones and rented or purchased application-specific devices may be used with systems of the present specification.

In this example, the personal electronic device (500) is displaying an exemplary portion (510) of a composite photographic image (510) received from an array of cameras at a certain vantage point at a live event. Icons (525, 530) such as a zoom icon (525) and a pan icon (530) on the screen may be selected with the stylus (540) to activate different tools that allow the spectator to alter the selected portion (510) of the composite photographic image. For example, using a zoom tool, the spectator may select a portion (535) of the composite photographic image that is a subset of what is being displayed on the screen (520) for a more detailed view of a specific aspect of the live event.

Various buttons (540, 545, 550, 555, 560) may be displayed on the screen (520) by the software to allow the spectator to select options with the stylus (540) relating to the images displayed on the screen. For example, one button (540) may allow the spectator to capture a still photo from the images displayed on the screen (520). Another button (545) may provide the option of recording start times and stop times for a video recording desired by the spectator. Still other buttons (550, 555, 560) may allow the spectator to switch to a composite image from a different array of cameras at another vantage point, view a main menu, or view more options, respectively.

Referring now to FIG. 5B, an exemplary internet browser window (561) is shown in which a remote spectator may be able to interact with received media content corresponding to the live event in much the same way as the spectators using the personal electronic device (500).

The spectator receiving media content from the live event via the internet browser window (561) may be able to view a portion of the composite photographic image received from the array of cameras at the live event. Different tools may be activated by the spectator selecting certain controls and options (255, 257, 258, 259, 261, 263, 265, 267, 269) in the internet browser window (561). These tools may be selected and/or controlled using an on-screen cursor (563) that is manipulated with a peripheral device, such as a mouse or touchpad, by the spectator.

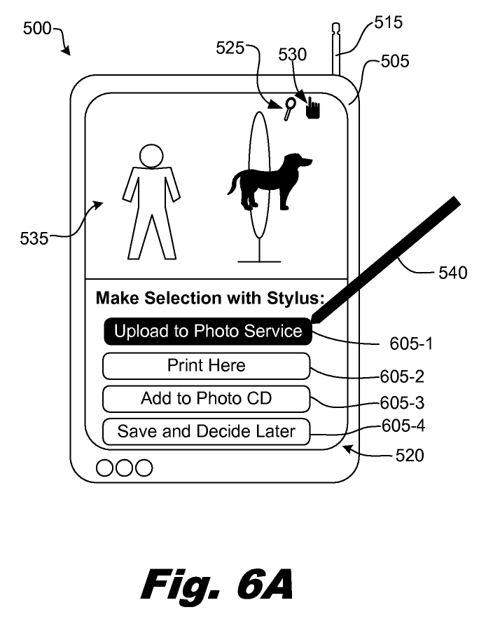

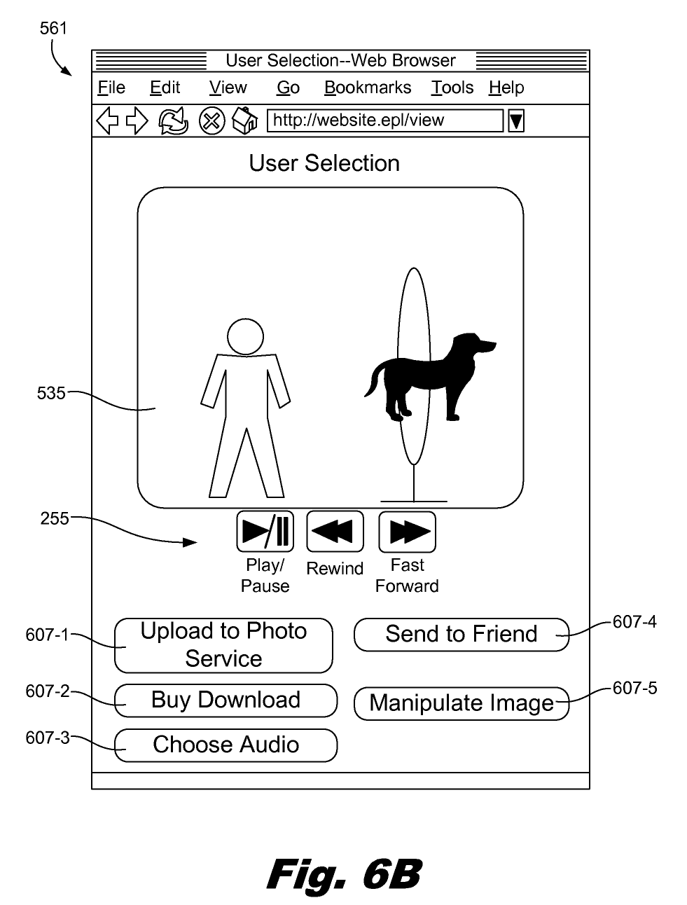

Referring now to FIGS. 6A-6B, the personal electronic device (500) and the exemplary internet browser window (561) are shown according to an exemplary scenario, in which a selected portion (535) of the received composite photographic image has been captured by the spectator as a still photograph. A spectator using the personal electronic device (500) may then select different buttons (605-1 to 605-4) displayed on the screen relating to uploading the selection to an online service, printing the selection at the venue, adding the selection to a file of selections for a photo compact disc (CD), and saving the selection and deciding later, respectively. When a button (605) is selected by the spectator, a visual indication of the selection such as a change in button display may occur.

A remote spectator using the exemplary internet browser window (561) of the present embodiment may also select different buttons (607-1 to 607-5) displayed on the screen relating to uploading the selection to an online service, such as a photo sharing and printing service, purchasing a downloaded copy of the selection, selecting audio tracks to accompany visual selections, sending the selection to a friend, and manipulating the image.

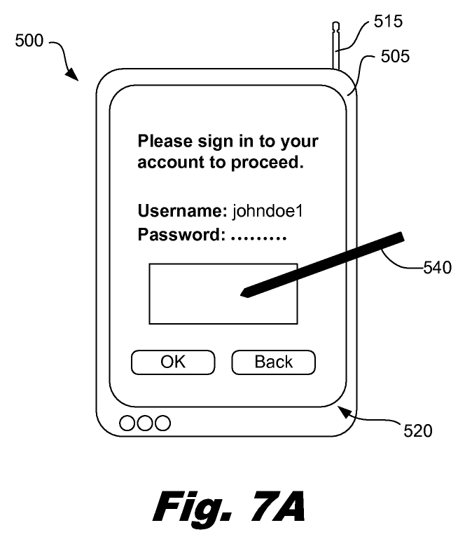

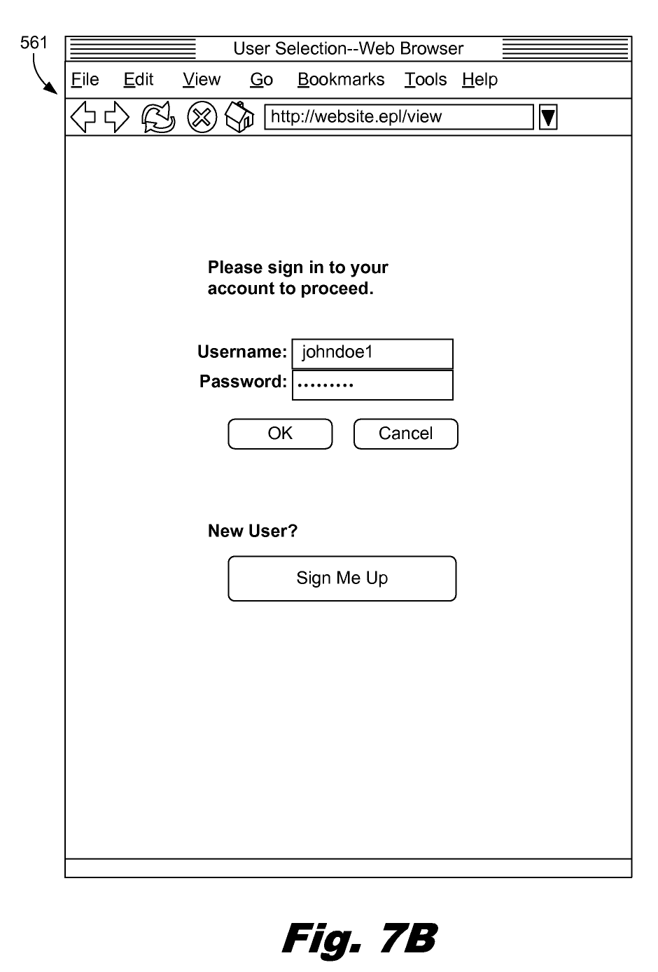

Referring now to FIGS. 7A-7B, the personal electronic device (500) and the internet browser window (561) are shown respectively, according to an exemplary scenario, in which a spectator has selected the option of uploading an image of his or her selection to an online photo service. The respective screens (520) are shown prompting the user to enter a username and password to the online photo service.

In FIG. 7A, the username and password may be entered into the personal electronic device (500) with the stylus (540). In FIG. 7B, the username and password may be entered into the internet browser window (561) using a keyboard or other peripheral device.

The username and password may have been previously established for the spectator online. In other embodiments, the spectator may have the option to sign up for a username and password with the online photo service using the personal electronic device (500) or the internet browser window (561). Once the spectator has authenticated his or her identity with the online photo service, photo printing or download options may be made available to the spectator by the online photo service on the personal electronic device (500) or through the internet browser window (561).

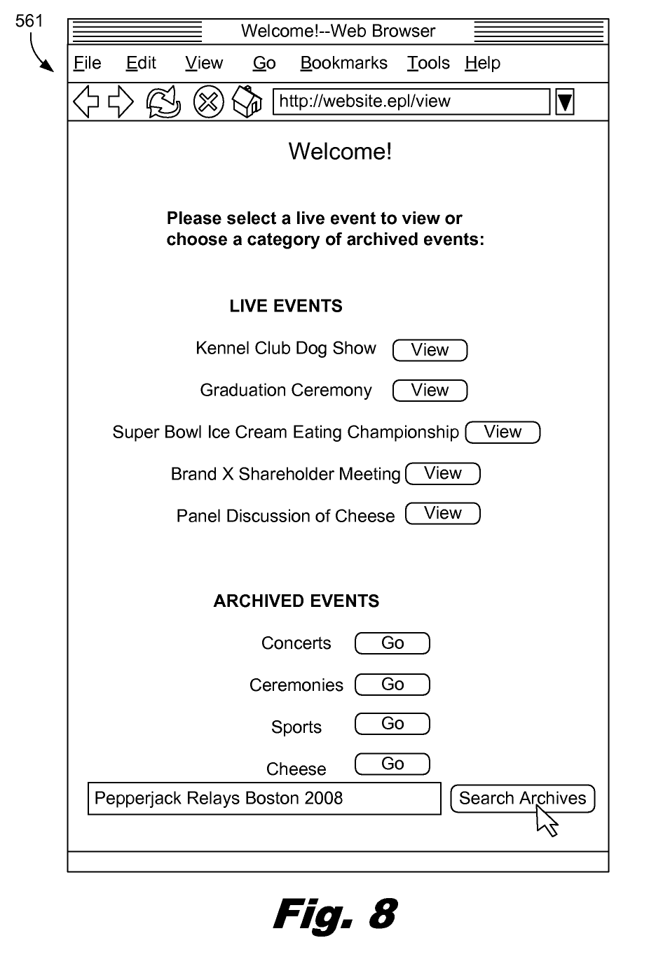

Referring now to FIG. 8, the internet browser window (561) is shown according to an exemplary scenario, in which a spectator is using a service that allows the spectator to select a live event from which to obtain media content. In the present example, the spectator may select from current live events or from archived live events. When an archived event is selected, the spectator may receive streaming media content through the internet browser window (561) similar to receiving a streaming feed of a live event. The spectator may select still photographs, video images, and/or audio content from both the current live events and the archived live events according to the principles above.

Certain features may be available to a spectator of an archived live event that may not ordinarily be available to spectators who view live events as they occur. For example, in an archived event a spectator may have more control over manipulating the playback of the event. Controls such as, but not limited to, forward play, reverse play, pause, slow motion, fast forward, rewind, may be available to viewers of archived live events.

### Exemplary Methods

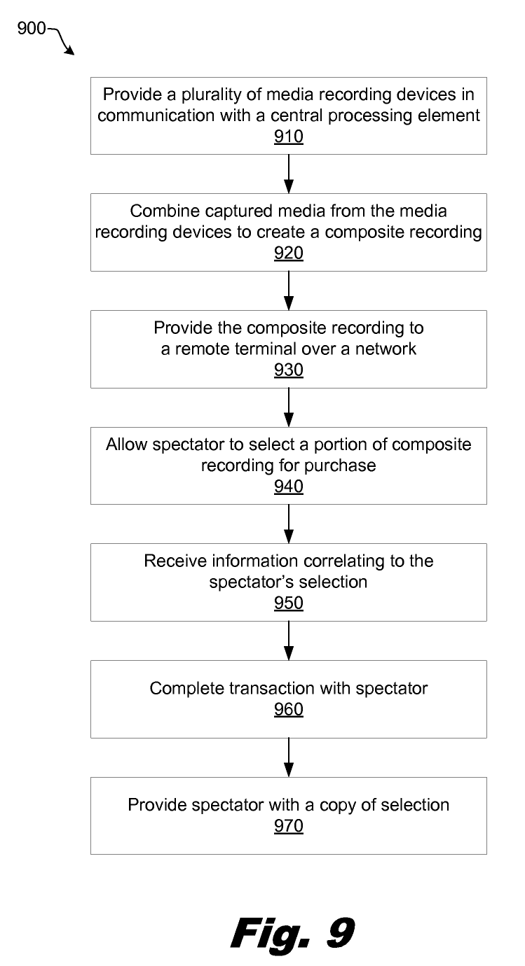

Referring now to FIG. 9, a flowchart illustrating an exemplary method (900) of live event media content to spectators is shown. In the method (900), a plurality of media recording devices is provided (step 910). The media recording devices are in communication with a central processing element. In some embodiments, the media recording devices may include high definition video cameras and microphones. Examples of central processing element consistent with this method include, but are not limited to, computers, servers, application-specific integrated circuits (ASICs), other processing devices, and combinations thereof.

Captured media content received from the media recording devices in the central processing element may then be combined (step 920) to create a composite recording. The composite recording may include, for example, a tiled view of the feed from each of a plurality of cameras or may include, for example, a panoramic view of a live event from a certain vantage point at which the plurality of video cameras is situated.

The composite recording is then provided (step 930) to a remote terminal over a network, such as the internet. The remote terminal may include a computing device configured to run an internet browser program or other software configured to receive the composite recording. In some embodiments, the composite recording may be provided to the remote terminal at a lower resolution that that of the original media content captured by the media recording devices.

A spectator is then allowed (step 940) to select a portion of the composite recording for purchase. Examples of portions of the composite recording available for purchase include, but are not limited to, photographic still shots, collections of photographic still shots, video images, collections of video images, audio, and combinations thereof.

Information correlating to the spectator's selection is then received (step 950). The information may be received in the central processing element, or in a separate apparatus. Once a transaction is completed (step 960) with the spectator, an electronic or physical copy of the selected portion of the composite recording is provided (step 970) to the spectator. Completing (step 960) the transaction may include the spectator providing, arranging, or assuring payment for the image(s). Examples of possible physical examples of the selection include, but are in no way limited to, compact discs (CDs), flash memory, physical prints, posters, albums, digital video discs (DVDs), other physical media, and combinations thereof.

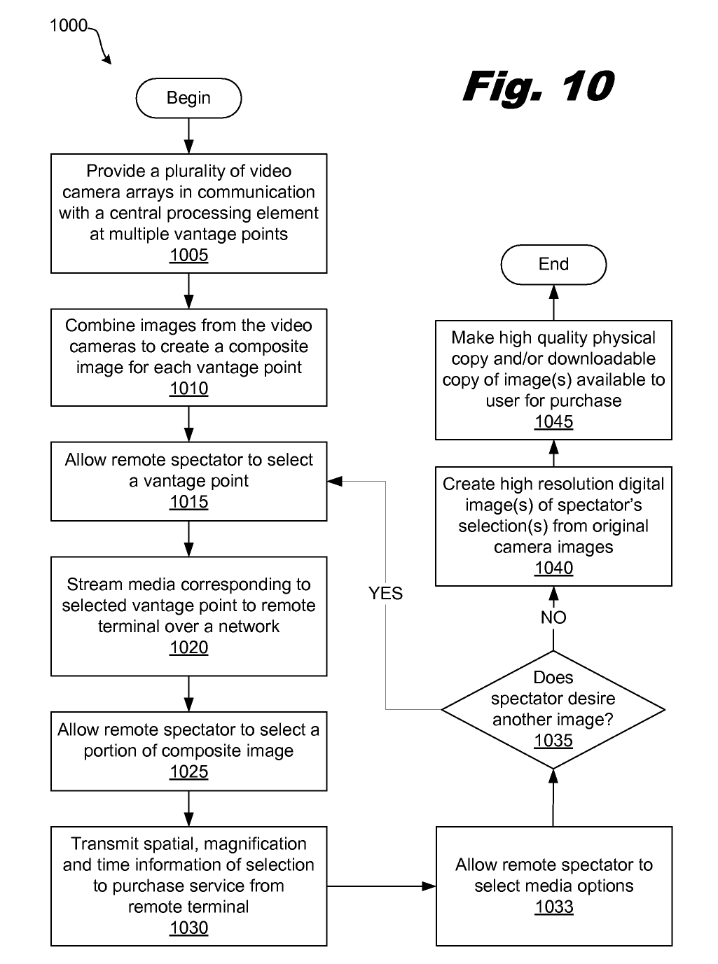

Referring now to FIG. 10, a flowchart illustrating an exemplary method (1000) of providing photographic images of live events to spectators is shown. According to the method, a plurality of video camera arrays are provided (step 1005) at multiple vantage points of a live event. Each of the arrays is in communication with a central processing element, as described in relation to previous figures. One or more microphones may also be provided at the live event to capture audio from the event. Additionally or alternatively, source audio may be transmitted directly to the central processing element for integration with the photographic images provided by the video camera arrays.

The images from the video cameras of each array are combined (step 1010) in the central processing element to create a composite image for each of the vantage points. A remote spectator of the live event is allowed (step 1015) to select a vantage point using a remote terminal in communication with the central processing element through a network of one or more devices, such as the internet. A version of the composite image corresponding to the selected vantage point is then broadcast to the spectator (step 1020) over the network through the remote terminal.

Once the version of the composite image has been received by the remote spectator, the spectator is allowed (step 1025) to select a portion of the composite image of which he or she may desire to obtain a physical or electronic copy. Spatial, magnification, and time information relating to the selection are transmitted (step 1030) to a purchase service from the remote terminal via the network. In alternate embodiments, the spatial, magnification, and time information relating to the selection may be recorded for a later transmission or other form of data transfer to the purchase service. The spectator may then be allowed (step 1033) to select media options from which the selection may be ordered. The media options may include, among other options, the type of media on which the spectator desires to receive the selection.

It is then determined (step 1035) if the spectator desires another image. If so, the spectator is allowed to select a vantage point (step 1015) and the steps of broadcasting (step 1020), allowing the spectator to select a portion of the composite image (step 1025), and transmitting information (step 1030) are repeated.

When the spectator does not desire another image, high resolution images of the spectator's selections are then created (step 1040) from the original camera images. High quality physical copies and/or downloadable electronic copies of the created photographic images are then made available (step 1045) to the spectator for purchase.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of providing media content of live events to a remote spectator, said method comprising:
obtaining media content from at least one media recording device at said live event;
providing a version of said content to a remote electronic device being used by said spectator over a network; and
receiving a selection of said media content or a portion of said media content selected by said spectator using said electronic device.

2. The method of claim 1, wherein said media recording devices comprise at least one of: cameras, microphones, and audio transducers.

3. The method of claim 1, wherein said step of obtaining media content from said at least one camera comprises producing a composite photographic image using images from a plurality of said cameras.

4. The method of claim 3, further comprising providing software to said spectator for said electronic device to permit said electronic device to receive said version of said media content.

5. The method of claim 4, wherein said software is provided to said electronic device in a web page accessed by said remote electronic device.

6. The method of claim 1, wherein said selection comprises a number of still images, a segment of a video image, a portion of a still image, an audio recording, a portion of an audio recording, or combinations thereof.

7. The method of claim 1, further comprising storing said selection along with an identification of said spectator making said selection in an online purchase service.

8. The method of claim 7, further comprising receiving payment from said spectator who is purchasing a copy of said selection from said online purchase service.

9. The method of claim 8, further comprising delivering said copy purchased by said spectator as a printed image, a still image stored on physical recording media, a video image recording stored on physical recording media, an audio recording stored on physical recording media, or an electronic copy, as requested by said spectator.

10. The method of claim 9, wherein said copy is downloaded to said remote electronic device over said network.

11. A method of providing photographic images of live events to a remote spectator, said method comprising:
providing a plurality of camera arrays, each camera array being situated at a vantage point of a live event;
creating a plurality of composite photographic images, each of said composite photographic images corresponding to one of said camera arrays;
streaming versions of said composite photographic images over a network to a remote electronic device used by said spectator; and
creating a copy of at least a portion of at least one of said composite photographic images as selected by said spectator, wherein said copy has a higher resolution than said versions of said composite images broadcast to said electronic device.

12. The method of claim 11, wherein said camera arrays comprise high-resolution video cameras.

13. The method of claim 11, wherein said network comprises the internet.

14. The method of claim 11, further comprising receiving spatial, magnification, and time information of said portion selected by said spectator from said electronic device over said network.

15. The method of claim 14, further comprising creating a digital image of said selected portion of said composite photographic image using original images from said cameras.

16. The method of claim 15, further comprising processing said original images to enhance at least one of appearance, quality, and sound of said selected portion.

17. A system for capturing media content of live events, comprising:
at least one media recording device at a said live event;
a processing element in communication with said at least one media recording device;
a remote electronic device being used by a spectator of said live event configured to receive a representation of media content from said media recording device over a network; and
an electronic storage module configured to receive information from said electronic device over said network identifying a media content selection comprising at least a portion of said media content selected by said spectator.

18. The system of claim 17, further comprising a system for producing a copy of said media content selection on physical media.

19. The system of claim 17, wherein said media content selection comprises a number of still images, a segment of a video image, a portion of a still image, an audio recording, a portion of an audio recording, or combinations thereof.

20. The system of claim 17, wherein said media recording device comprises at least one of: cameras, microphones, and audio transducers.
